(19) United States
(12) Patent Application Publication
(10) Pub. No.: US 2003/0081607 A1
(43) Pub. Date: May 1, 2003

(54) General packet radio service tunneling protocol (GTP) packet filter

(76) Inventor: Alan Kavanagh, Walnut Creek, CA (US)

Correspondence Address: ERICSSON INC., 6300 LEGACY DRIVE, M/S EVW2-C-2, PLANO, TX, 75024, US

(21) Appl. No.: 10/173,484

(22) Filed: Jun. 17, 2002

Related U.S. Application Data
(60) Provisional application No. 60/336,426, filed on Oct. 30, 2001.

(51) Int. Cl. H04L 12/56

(52) U.S. Cl. 370/392; 370/466

(57) ABSTRACT

A method of filtering data packets in General Packet Radio Service (GPRS) Tunneling Protocol (GTP) signaling messages. Selected messages from GTP Path Management, GTP Tunnel Management, GTP Mobility Management, and GTP Location Management messages are analyzed against a plurality of filtering criteria, and data packets that do not meet the filtering criteria are dropped while data packets that meet the criteria are passed. The data packets may be analyzed to verify that they contain correct source, destination, and mask addresses, and that they contain UDP/TCP port numbers that are consistent with the GTP version number. The packets are also inspected at the GTP level, layer-5, and based on the GTP version, information in the GTP header, and accompanying Information Elements (IEs), selected data packets are dropped.

### PRIORITY STATEMENT UNDER 35 U.S.C. §119(e) & 37 C.F.R. §1.78

This nonprovisional application claims priority based upon the prior U.S. provisional patent application entitled, “GTP Filter”, application Ser. No. 60/336,426, filed Oct. 30, 2001 in the name of Alan Kavanagh.

### BACKGROUND OF THE INVENTION

1. Technical Field of the Invention

This invention relates to telecommunication systems. More particularly, and not by way of limitation, the present invention is directed to a method of limiting and filtering Internet Protocol (IP) packets when utilizing the General Packet Radio Service (GPRS) Tunneling Protocol (GTP) to transport control messages and user data in the form of Packet Data Units (PDUs) between GPRS Service Nodes (GSNs).

2. Description of Related Art

FIG. 1 is a simplified block diagram of an existing GPRS network 10, with two Mobile Stations (MSs) 11 and 16 attached. An MS is a combination of a Mobile Terminal (MT) which may be a GPRS mobile phone and/or a GPRS PCMCIA card that has GPRS functionality, and a Terminal Equipment (TE) which may be, for example, a laptop computer or Personal Digital Assistant (PDA). As illustrated, MS 11, comprising TE 12 and MT 13, connects to the network through a Base Station System (BSS) 14. The BSS communicates with a Serving GPRS Support Node (SGSN) 15 over a Gb interface. MS 16, comprising TE 17 and MT 18, connects to the network through a Universal Terrestrial Radio Access Network (UTRAN) 19. The UTRAN communicates with an SGSN 21 over an Iu interface. The SGSNs communicate with a Gateway GPRS Support Node (GGSN) 22 over a Gn and Gp interface.

The SGSNs 15 and 21, and the GGSN 22 are network control nodes. The SGSN is basically a gateway to the GPRS packet data network 10, and the MS is attached to the GPRS network at the current Access Point, i.e., the SGSN node. The GGSN is an access server/gateway that communicates over a Gi interface with an external Packet Data Network (PDN) 23 such as a Virtual Private Network (VPN) or Internet Service Provider (ISP) network. The GGSN may also provide a Gp interface to an SGSN 24 located in another Public Land Mobile Network (PLMN) 25. The GGSN may also communicate with a Home Location Register (HLR) 26 over a Gc interface.

The GTP protocol is split into two planes, the GTP-Control Plane and the GTP-User Plane. The GTP-Control Plane is a signaling plane utilized to (1) establish a GTP Tunnel between the GSN nodes, (2) tear down the tunnel when transmission is finished, (3) maintain the state of the GTP connection, and (4) handle GTP connection updates when the MS roams from one SGSN to another SGSN. The GTP-User Plane is utilized to transmit the PDUs the MS is transmitting and receiving from the external network, for example the Internet or a corporate network. There are currently two releases for GTP, GTP version 0 release 1997, and GTP version 1 release 1999.

When an MS such as MS 11 attaches and registers with the GPRS network 10, the MS initiates an Activate PDP Context Request and may specify the Access Point Name (APN), Quality of Service (QoS), Protocol Configuration Options (PCO), and so on. The SGSN 15 receives the APN and uses this “label string” to locate which GGSN is connected to/servicing the external PDN 23 to which the MS user is requesting a connection. This APN is sent in a human-readable format, and the SGSN must translate this symbolic name to a logical name, i.e. to an IP address of the GGSNs that can handle/service the requested APN. The SGSN sends a Domain Name Server (DNS) Query to a DNS Server (not shown) requesting the DNS Server to resolve the APN into a logical IP address of the GGSN node or nodes. The DNS Server returns a list of IP addresses of all possible GGSN nodes that are connected to the external PDN 23.

FIG. 2 is a signaling diagram illustrating the GTP control messages utilized to initialize a PDP Context and establish a GTP Tunnel. The MS 11 sends an Activate PDP Context Request message 31 to the SGSN 15 and includes the APN, required QoS, and other configuration options. The SGSN 15 sends a Create PDP Context Request message 32 to the first GGSN 22 in the list of IP addresses returned by the DNS Server. This is the first step in establishing a GTP Tunnel. This message may be sent over User Datagram Protocol (UDP) for IP-based networks or Transmission Control Protocol (TCP) for X.25-based networks. If the GGSN is reachable, it responds by sending a Create PDP Context Response message 33 to the SGSN with a cause value “Request Accepted” (depending on the create request being successful and user authorized and authenticated), and includes its IP address and the QoS and configuration that it can provide to the MS. The SGSN then sends an Activate PDP Context Accept message 34 to the MS. A GTP Tunnel is now established for this MS user between the SGSN and GGSN nodes. A GTP tunnel is established for every PDP Context per MS that is granted access to the GPRS network and the external service requested. GTP-Control Plane signaling is conducted over two GPRS interfaces, the Gn interface which connects the SGSN and GGSN nodes in the operator's own PLMN network, and the Gp interface which is used to connect GSN nodes in different PLMN networks. GTP-User Plane signaling is established over the Gn and Gp interface for a GPRS network, and is extended to the Iu interface towards the UTRAN for a UMTS network.

FIG. 3 is a signaling diagram illustrating the GTP control messages utilized to delete a PDP Context and tear down a GTP Tunnel. The GTP Tunnel can be torn down by initiating a Detach Request 35, by either the operator or the MS 11. A mobile-originated detach request is sent to the SGSN 15 which, in turn, sends a Delete PDP Context Request message 36 to the GGSN 22. The GGSN deletes the PDP Context for this MS and responds with a Delete PDP Context Response message 37 to the SGSN. The SGSN sends an International Mobile Station Identifier (IMSI) Detach Indication 38 and GPRS Detach Indication 39 to the GGSN. The SGSN then deletes the PDP Context, and sends a Detach Accept message 40 to the MS. As a result, the GTP tunnel is deleted.

All Path Management, Tunnel Management, Mobility Management, and Location Management signaling messages sent between the GSN nodes are encapsulated in GTP packets. The peer nodes exchange GTP messages with no integrity check. Peer nodes are trusted based on their IP addresses and the port numbers used for GTP. GTP maintains state with its peers in all message types by sending a response after receiving a request message. Therefore, valuable network resources can be tied up if an attacker sends a large number of false request messages to which receivers must respond. Additionally, malicious attacks, Denial of Service (DoS) attacks, and “bandwidth soaked” attacks transmit response messages when a request was never sent. Furthermore, GTP signaling messages may be altered in transit, thereby enabling fraudulent attacks in which the sender or receiver of the GTP messages is impersonated. For all these reasons, GTP messages are currently susceptible to DoS attacks, malicious attacks, and session hijacking. Telecommunication networks have been built on a trust-based model that does not anticipate the types of attacks that GPRS can bring to the operator's network.

In order to overcome the disadvantages described above, it would be advantageous to have a method of filtering IP packets when utilizing GTP signaling messages between GSNs in a GPRS network. Such a method would, to a certain degree, limit the effects of attacks such as DoS attacks, malicious attacks, and session hijacking. The present invention provides such a method.

### SUMMARY OF THE INVENTION

In one aspect, the present invention is directed to a method of filtering data packets in General Packet Radio Service (GPRS) Tunneling Protocol (GTP) signaling messages between service nodes in a GPRS network. The method includes the steps of analyzing at least one GTP signaling message against a plurality of filtering criteria, and responsive to the analyzing step, selectively dropping data packets from the GTP signaling message or allowing the packets to pass. The analyzing step may include analyzing messages selected from a group consisting of GTP Path Management messages, GTP Tunnel Management messages, GTP Mobility Management messages, and GTP Location Management messages. The analysis may include the steps of verifying that the data packets in the GTP signaling message contain correct source, destination, and mask addresses; verifying that the data packets in the GTP signaling message contain User Datagram Protocol/Transmission Control Protocol (UDP/TCP) port numbers that are consistent with the GTP version number; and inspecting the data packets at the GTP level, layer-5. Based on information in the GTP header and accompanying Information Elements (IEs), selected GTP packets are dropped.

In another aspect, the present invention is directed to a method of filtering data packets in GTP signaling messages that includes the steps of analyzing selected messages from GTP Path Management messages, GTP Tunnel Management messages, GTP Mobility Management messages, and GTP Location Management messages against a plurality of filtering criteria; and responsive to the analyzing step, dropping data packets that do not meet the filtering criteria while allowing data packets that meet the criteria to pass and denying or permitting GTP-User Plane data packets. The method may also include limiting the number and type of GTP-User Plane messages that are passed through.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram of an existing GPRS network to which two MSs are attached;

FIG. 2 (Prior Art) is a signaling diagram illustrating the GTP control messages utilized to initialize a PDP Context and establish a GTP Tunnel;

FIG. 3 (Prior Art) is a signaling diagram illustrating the GTP control messages utilized to delete a PDP Context and tear down a GTP Tunnel;

FIG. 4 is a flow chart illustrating the overall method of filtering GTP packets in the preferred embodiment of the present invention;

FIG. 5 is a flow chart illustrating the analysis and filtering performed on Echo Request and Echo Response messages in the preferred embodiment of the present invention;

FIG. 6 is a flow chart illustrating the analysis and filtering performed on Create PDP Context messages in the preferred embodiment of the present invention;

FIG. 7 is a flow chart illustrating the analysis and filtering performed on Update PDP Context messages in the preferred embodiment of the present invention;

FIG. 8 is a flow chart illustrating the analysis and filtering performed on Delete PDP Context messages in the preferred embodiment of the present invention;

FIG. 9 is a flow chart illustrating the analysis and filtering performed on Create AA PDP Context messages in the preferred embodiment of the present invention;

FIG. 10 is a flow chart illustrating the analysis and filtering performed on Delete AA PDP Context messages in the preferred embodiment of the present invention;

FIG. 11 is a flow chart illustrating the analysis and filtering performed on Error Indication messages in the preferred embodiment of the present invention;

FIG. 12 is a flow chart illustrating the analysis and filtering performed on PDU Notification messages in the preferred embodiment of the present invention;

FIG. 13 is a flow chart illustrating the analysis and filtering performed on PDU Notification Reject messages in the preferred embodiment of the present invention;

FIG. 14 is a flow chart illustrating the analysis and filtering performed on Identification messages in the preferred embodiment of the present invention;

FIG. 15 is a flow chart illustrating the analysis and filtering performed on SGSN Context messages in the preferred embodiment of the present invention;

FIG. 16 is a flow chart illustrating the analysis and filtering performed on Forward Relocation messages in the preferred embodiment of the present invention; and

FIG. 17 is a flow chart illustrating the analysis and filtering performed on Relocation Cancel messages in the preferred embodiment of the present invention.

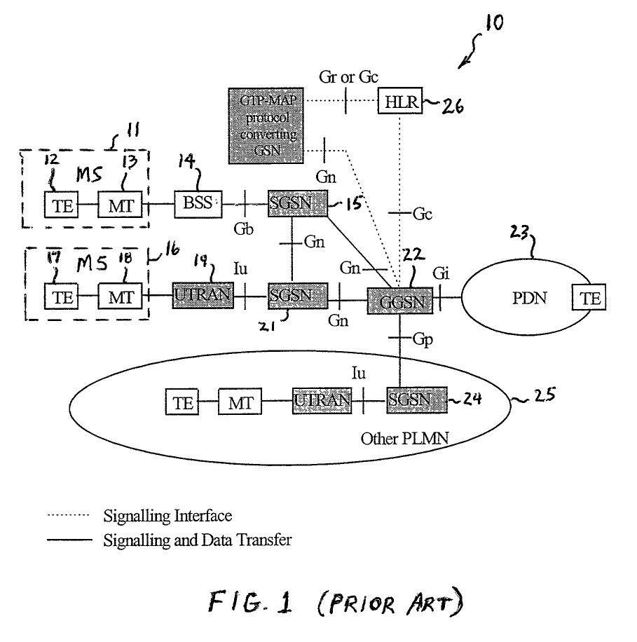

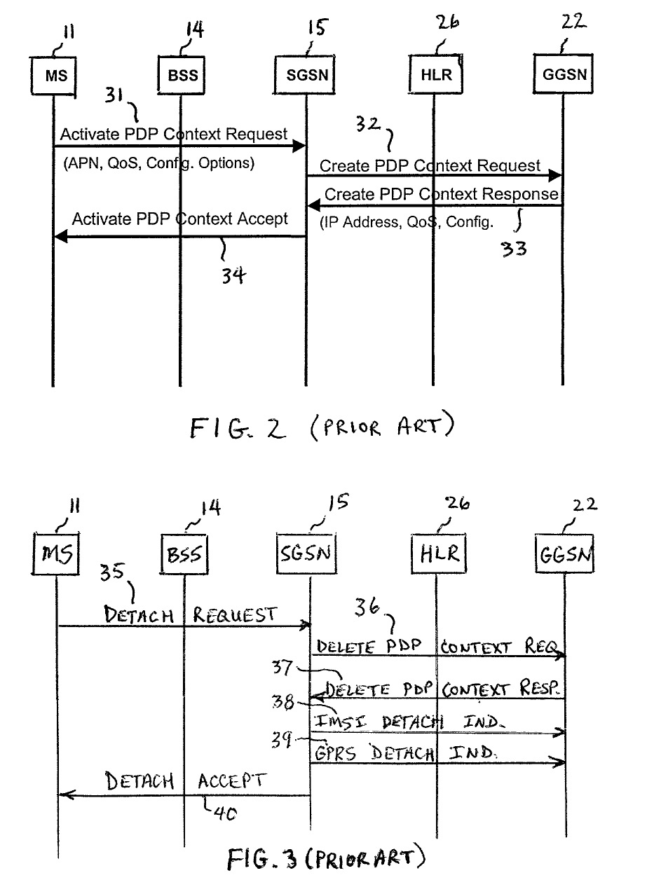

### DETAILED DESCRIPTION OF EMBODIMENTS

This nonprovisional application incorporates by reference herein, the prior U.S. provisional patent application entitled, “GTP Filter”, application Ser. No. 60/336,426, filed Oct. 30, 2001 in the name of Alan Kavanagh.

The GTP Filter of the present invention inspects all GTP packets and performs specific filtering rules based on source and destination addresses, the message type, and the GTP version number of the GTP packet in the GTP header. This limits the effect of DoS attacks, DDoS attacks, malicious attacks, bandwidth soaked attacks, tunnel hijacking, and accessibility from other PLMN networks. The GTP Filter also limits the number of GTP-Control Plane and User Plane messages that can be passed through the GTP Filter and what messages are permitted and denied.

The present invention inspects, analyzes, and filters the GTP Packets/messages from numerous aspects. The need to perform this filtering arises from different sources as listed below. This list is not exhaustive.

1. GTP has a Path Management Protocol utilized to check the state of peer GSN nodes for which a PDP Context has been established. Path Management is performed whenever two GSN nodes are in communication in an active PDP Context, i.e. a GTP Tunnel is established between the two GSN nodes. However, Path Management may also be utilized for a DoS or Distributed-DoS (DDoS) attack, and therefore, the present invention inspects this message type. These types of attacks are applicable to all GTP message types.

2. Some users may have a subscription with their Home PLMN network through a pre-paid service, and may be registered as an Anonymous Access user. The present invention may prohibit this type of user from having access to certain PLMN Networks and APNs even though the Home PLMN network has a Roaming agreement with this Visited PLMN Network.

3. A PLMN operator is susceptible to having contexts spoofed. Some contexts may be created by the GSN nodes only to find that after processing the packet, the request has no merit and is not valid in this network. The present invention detects and limits these events.

4. A Delete PDP Context Request may constitute a malicious attack if the Delete PDP Context Request did not originate from a valid peer. This results in the MS being disconnected from the current service and initiating another Activate PDP Context Request. The present invention detects and limits these events.

5. IP Spoofing can be easily done after a PDP Context has been established and the IP address has been dynamically assigned. The present invention detects and limits these events.

6. The authenticity of all messages cannot be guaranteed. GTP does not provide any way to authenticate the sender of a GTP message, and as a result, the receiver is forced to respond to the messages. This can lead to a DoS or malicious attack. The present invention detects and limits these events.

7. An Update Context may be requested in the form of a malicious attack, and as a result, the PDP Context is switched to a malicious peer. This is called “Tunnel Hijacking”. The present invention detects and limits these events.

8. Message types can be spoofed so that when an MS is connected to the GPRS network and service is requested, an attacker can send a Delete PDP Context message forcing the GGSN to delete the PDP Context for this MS when the network or MS did not request to be disconnected. The present invention detects and limits these events.

9. GTP maintains state with its peers in all message types by sending a response after receiving a request message. Therefore, valuable network resources can be tied up if an attacker sends a large number of false request messages that must be responded to. Additionally, malicious attacks, DoS attacks, and “bandwidth soaked” attacks transmit response messages when a request was never sent. The present invention detects and limits these events.

10. An MS in a Visited GPRS PLMN connected to the Visited SGSN may request an APN that is only served by his Home GGSN. The present invention considers the Visited Network that the MS is currently in to be unsecured, and does not allow the MS to access this Private APN from the untrusted PLMN. This filtering is done on the APN, MSISDN, and IP address of the signaling GSN node.

Since no stateful inspection exists today to determine whether a particular message type is permitted, all GTP message types are passed through firewalls. GTP Packets are identified by firewalls today based on their port numbers and the source and destination IP addresses. As a result, today's firewalls are unable to control the rate at which GTP packets are sent and received to and from the GSN nodes in the PLMN network, and their neighboring PLMN networks with whom they have a roaming agreement. The firewalls are unable to prioritize message types for processing, and are unable to determine which message types are permitted to be passed to the GSN nodes to be further processed, or which messages should be dropped at the firewall. Thus, GTP can be used to launch DoS attacks against the GPRS PLMN operator's network and also for Tunnel Hijacking.

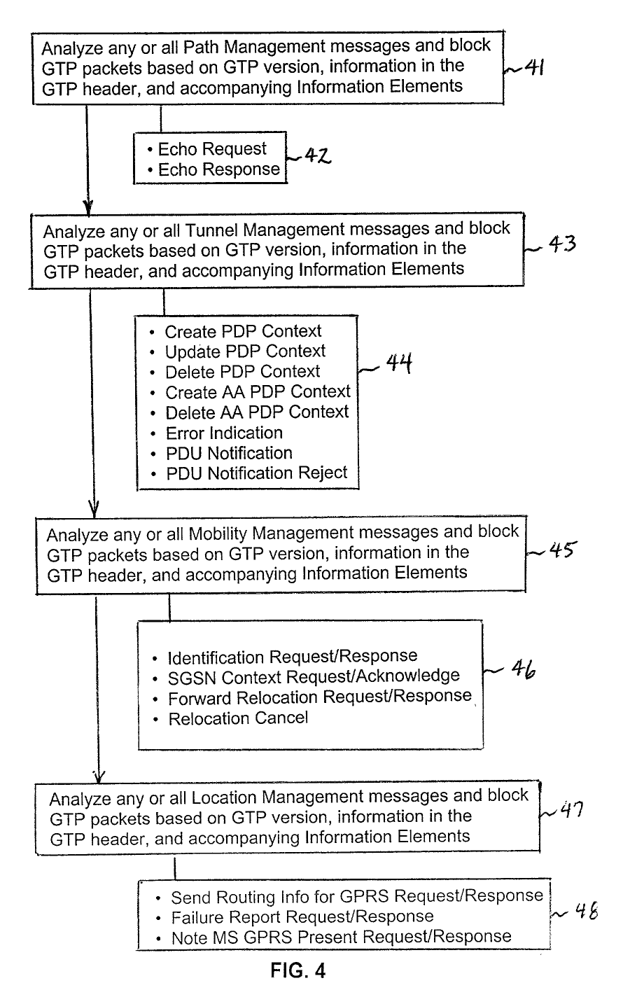

FIG. 4 is a flow chart illustrating the overall method of filtering GTP packets in the preferred embodiment of the present invention. The source and destination IP addresses and port number are first checked before GTP filtering is started on the inbound/outbound packet. Based on information in the GTP header, accompanying Information Elements (IEs), and the GTP version number, GTP messages are filtered and selected GTP packets are blocked. At step 41, any or all of the Path Management messages utilized in the GTP protocol are analyzed. Based on the information in the GTP header, accompanying IEs, and the GTP version number, selected GTP packets are blocked. As shown at 42, the GTP Filter may select messages for analysis from a group that includes the GTP Echo Request and Echo Response messages.

At step 43, any or all of the Tunnel Management messages utilized in the GTP protocol are analyzed. Based on the information in the GTP header, accompanying IEs, and the GTP version number, selected GTP packets are blocked. As shown at 44, the GTP Filter may select messages for analysis from a group that includes the GTP Create PDP Context, Update PDP Context, Delete PDP Context, Create Anonymous Access (AA) PDP Context, Delete AA PDP Context, Error Indication, PDU Notification, and PDU Notification Reject messages.

At step 45, any or all of the Mobility Management messages utilized in the GTP protocol are analyzed. Based on the information in the GTP header, accompanying IEs, and the GTP version number, selected GTP packets are blocked. As shown at 46, the GTP Filter may select messages for analysis from a group that includes the GTP Identification, SGSN Context, Forward Relocation, and Relocation Cancel messages.

At step 47, any or all of the Location Management messages utilized in the GTP protocol are analyzed. Based on the information in the GTP header, accompanying IEs, and the GTP version number, selected GTP packets are blocked. As shown at 48, the GTP Filter may select messages for analysis from a group that includes the GTP Send Routing Info for GPRS, Failure Report, and Note MS GPRS Present messages.

It should be noted that GTP-User Plane messages are also filtered. For example GTP-User Plane packets are only allowed to pass after a PDP Context has been successfully received, otherwise the packet is dropped. Also, Line Rate Limiting is applied to GTP-User Plane message types.

Path Management

Path Management is used to check the status of a GSN node and/or an RNC peer which is currently participating in an active PDP Context. To date, Path Management has been performed on a peer-to-peer basis (for example, GSN node to GSN node). For GTP Releases 1997 and 1999, an Echo Request/Response may not be sent more often than every 60 seconds on each path. The GTP Header indicates the message type. This message type is set to “Echo Request” or “Echo Response”.

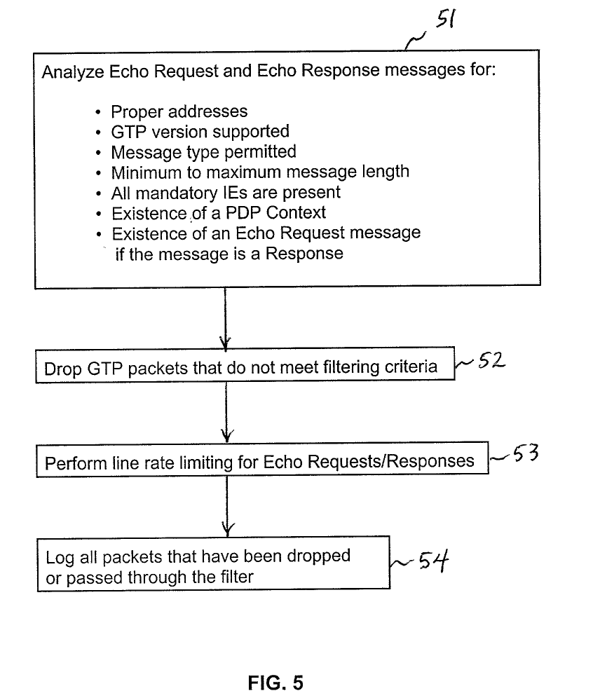

FIG. 5 is a flow chart illustrating the analysis and filtering performed on Echo Request and Echo Response messages in the preferred embodiment of the present invention. At step 51, the GTP Filter looks first at the source and destination IP addresses and the port number for each SGSN and GGSN, and permits the packet once the source and destination address are validated. If the source and destination IP address and masks match, the packet is then inspected based on the UDP port number. For GTP Releases 1997 and 1999, the port numbers are 3386 and 2123, respectively. If the subsequent IP addresses and port numbers are correct, the packet is considered to be a GTP packet. The GTP Filter of the present invention additionally processes and inspects the packet at the GTP level, (i.e., Open Systems Interconnect (OSI) layer-5). The GTP version number is checked in the GTP header to determine whether the version is supported, and if not, the packet is dropped and logged. Alternatively, the first packet based on source and destination IP addresses may be passed through. Next, the message type is checked to determine whether or not it is of a type that is permitted (for example, Echo Request or Echo Response), and is logged accordingly. The minimum to maximum message length is also checked in accordance with the message type, and it is verified that all mandatory IEs are present. For an Echo Request message, the GTP Filter verifies that a single PDP Context currently exists between the originator of the message and the receiver (destination IP address). If not, the packet is dropped at the GTP Filter.

The GTP Filter permits an Echo Response message only when an Echo Request has first been received from the peer GSN node. Having done this, the packet that has a message type of Echo Request/Response is permitted to pass through the GTP Filter. Thus, as shown at step 52, GTP packets that do not meet the filtering criteria are dropped, while those meeting the criteria are passed through the filter. At step 53, line rate limit is imposed based on the message type (Echo Request/Response) on a peer-to-peer basis. All packets that have been dropped or have passed through the GTP Filter may be logged at step 54. Optionally, priority queuing may be applied based on the GTP message type.

Tunnel Management

A. Create PDP Context

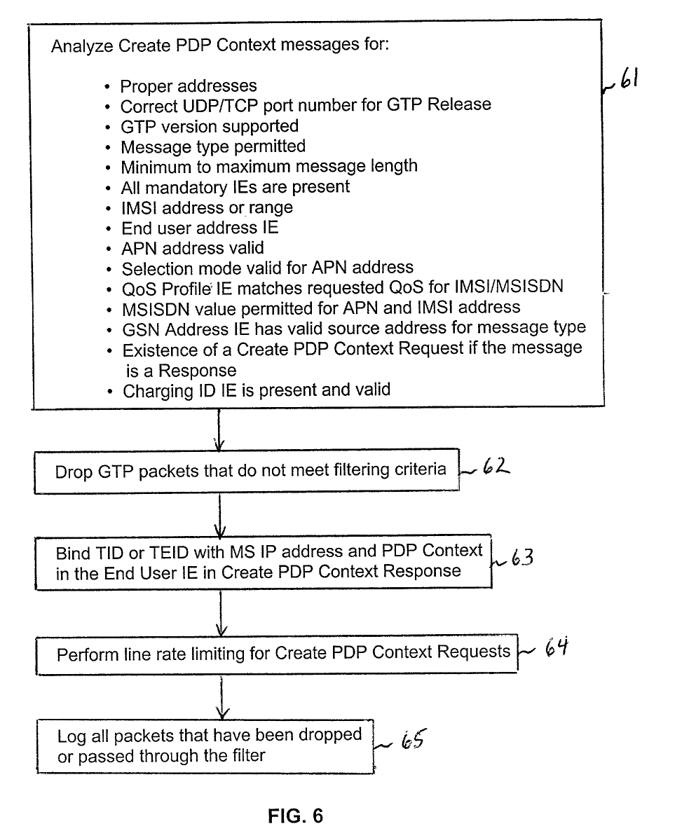

FIG. 6 is a flow chart illustrating the analysis and filtering performed on Create PDP Context messages in the preferred embodiment of the present invention. At step 61, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. At layer-5, the version number is checked in the GTP header to see if the version is supported, and if not the packet is dropped and logged. Next, the message type (i.e., Create PDP Context Request or Create PDP Context Response) is checked to determine whether that message type is permitted from this GSN node, and is logged accordingly. Additionally, the minimum to maximum message length is checked in accordance with the message type, and it is verified that all mandatory IEs are present.

Additionally, the GTP Filter checks the IMSI address or IMSI range based on the mnc and mcc of the operator in accordance with the source address of the request. The End User Address IE is also checked. This check compares the length of the IE with the length expected based on the APN requested. In other words based on the IMSI and the APN address, the length value is checked accordingly for this request. The PDP Type Organization and PDP Type Number are checked to determine whether these are supported for this request in the user's GSN nodes. For example, if only Ipv4 is supported, and the PDP Type Number specifies Ipv6, then the request may be dropped by the GTP Filter.

The GTP Filter also determines whether the APN address is valid in the network. The GTP Filter determines whether the APN is permitted based on the source IP address of the request and the end user address. The GTP Filter also checks that the selection mode is valid for this APN address. The APN specified in the Create PDP Context Request IE may permit only a subscriber-verified selection mode value. If the value is different, the packet is dropped because the selection mode is not valid, and/or the MS or network-provided APN subscription is not verified. The GTP Filter may also check the QoS Profile IE against what is requested for this IMSI/MSISDN. Likewise, the MSISDN value may be checked to determine whether it is permitted for the APN requested. The MSISDN may also be compared against the IMSI address, and a determination may be made as to whether connection is permitted from this SGSN, if it is a visiting SGSN.

The GSN Address IE may also be checked for a valid source address for a request of this message type. If the message Type is Create PDP Context Response, the GTP Filter may check that a Create PDP Context Request initially exists for this Create PDP Context Request based on the source and destination of the request, the IMSI, and the APN address. If a Create PDP Context Request was not sent, then the packet is dropped and logged at the GTP Filter, or is sent through the GTP Filter. The GTP Filter may also verify that the IE with the charging ID is present, and that the charging ID is valid (i.e., not 0).

Thus, as shown at step 62, GTP packets that do not meet the filtering criteria are dropped, while those meeting the criteria are passed through the filter. The GTP Filter may also prevent IP Spoofing at step 63 by binding the Tunnel Identifier (TID) or Tunnel Endpoint Identifier (TEID) with the IP address assigned to this MS and this PDP Context in the End User IE in the Create PDP Context Response message. At step 64, the GTP Filter may also perform Line Rate Limiting for Create PDP Requests. This can additionally be based upon the mnc mcc, source and destination IP addresses, the APN requested, and the IMSI address. Optionally, priority queuing may be applied based on the GTP message type. All packets that have been dropped or have passed through the GTP Filter may be logged at step 65.

B. Update PDP Context

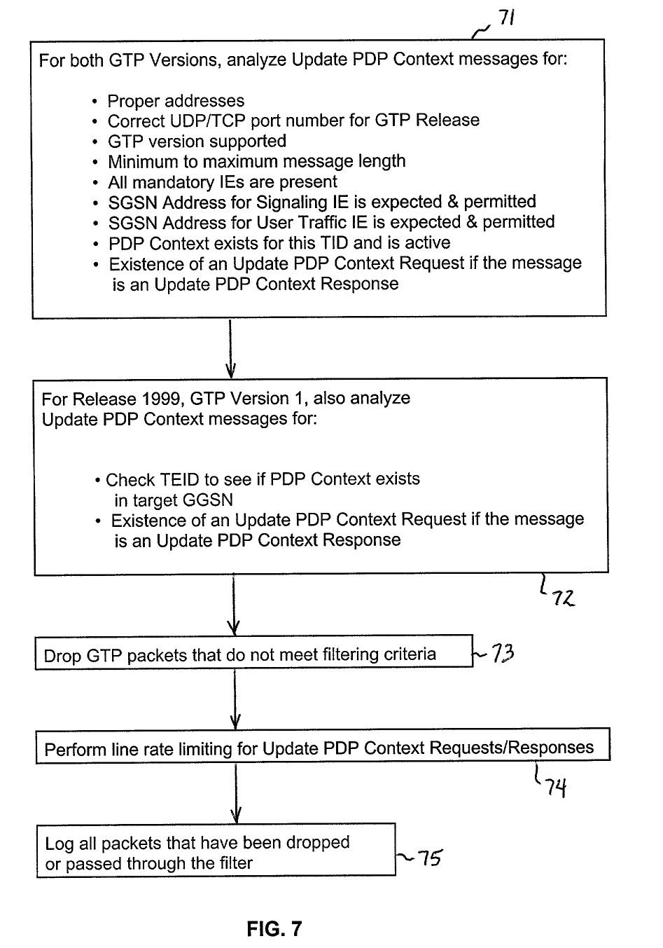

FIG. 7 is a flow chart illustrating the analysis and filtering performed on Update PDP Context messages in the preferred embodiment of the present invention. At step 71, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. For both GTP versions (Version 0 Release 1997 and Version 1 Release 1999 ), the following steps shown at 71 are applied to the Update PDP Context Request/Response message types. First, the version number is checked in the GTP header to determine whether the version is supported, and if not the packet is dropped and logged. The minimum to maximum message length is then checked in accordance with the message type, and it is verified that all mandatory IEs are present. The GTP Filter then verifies that the IE “SGSN Address for Signaling” is that of an expected/permitted IP address. The GTP Filter also verifies that the IE “SGSN Address for User Traffic” is that of an expected/permitted IP address. It is then determined that the MS has an active PDP Context residing on the target GGSN by analyzing the TID value in the GTP header. An Update PDP Context response is only permitted through the GTP Filter when an Update PDP Context Request Message Type has been received.

For GTP version 1 Release 1999, the following additional checks shown at step 72 are performed, providing additional security for the Update PDP Context Request Message type. First, the TEID is checked to verify that a PDP Context exists in the target/designated GGSN, and if so, the packet is permitted to pass through the GTP Filter and is logged. If a PDP Context does not exist, then the packet is dropped and logged at the GTP Filter. The Update PDP Context Request message type is also logged, and an Update PDP Context Response is permitted through the GTP Filter based on an Update PDP Context Request being successfully received for this PDP Context. Thus, as shown at step 73, GTP packets that do not meet the filtering criteria are dropped, while those meeting the criteria are passed through the filter. At step 74, Line Rate Limiting may also be applied to the Delete PDP Context Request/Response Message types. All packets that have been dropped or have passed through the GTP Filter may be logged at step 75.

C. Delete PDP Context

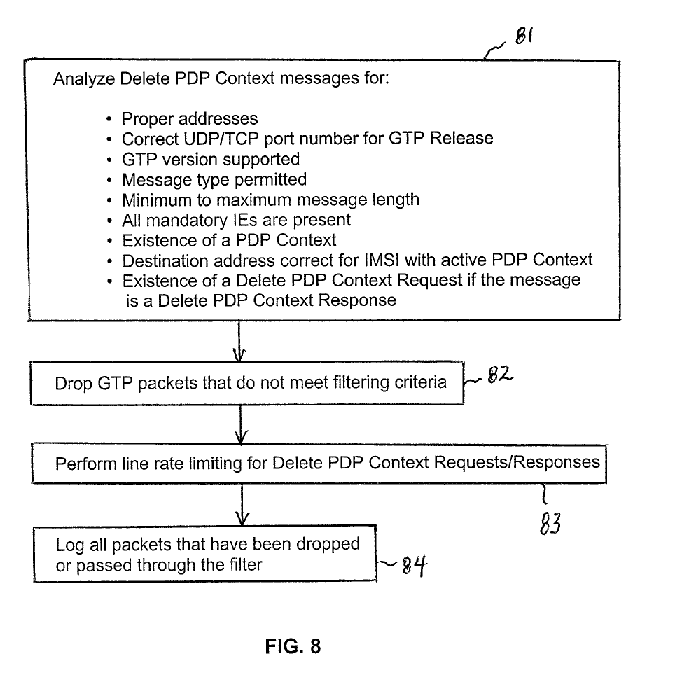

FIG. 8 is a flow chart illustrating the analysis and filtering performed on Delete PDP Context messages in the preferred embodiment of the present invention. At step 81, as for all messages and packets traversing the Gn and Gp interfaces, the GTP packets are first checked against the correct source and destination and mask addresses. Next, the packets are checked against the expected UDP/TCP port numbers, 3386 and 2123. The version number is then checked in the GTP header to see if the version is supported, and if not the packet is dropped and logged. Next, the message type is checked to determine whether or not the message type (i.e., Delete PDP Context Request or Delete PDP Context Response) is permitted. The result is logged accordingly. The minimum to maximum message length is then checked in accordance with the message type, and it is verified that all mandatory IEs are present.

Next, the GTP Filter checks the IMSI address and/or TID or TEID ensuring that a PDP Context exists for this IMSI. If not, the packet is dropped. The GTP Filter may also check the destination address of the request at layer-3. The message is considered valid if the destination address is the correct address where the IMSI has an active PDP Context. For a Delete PDP Context Response, the GTP Filter verifies that a Delete PDP Context Request message was first sent for this IMSI, and if not, the packet is dropped. Thus, as shown at step 82, GTP packets that do not meet the filtering criteria are dropped, while those meeting the criteria are passed through the filter. At step 83, Line Rate Limiting may also be applied to the Delete PDP Context Request/Response Message types. All packets that have been dropped or have passed through the GTP Filter may be logged at step 84.

D. Create Anonymous Access (AA) PDP Context

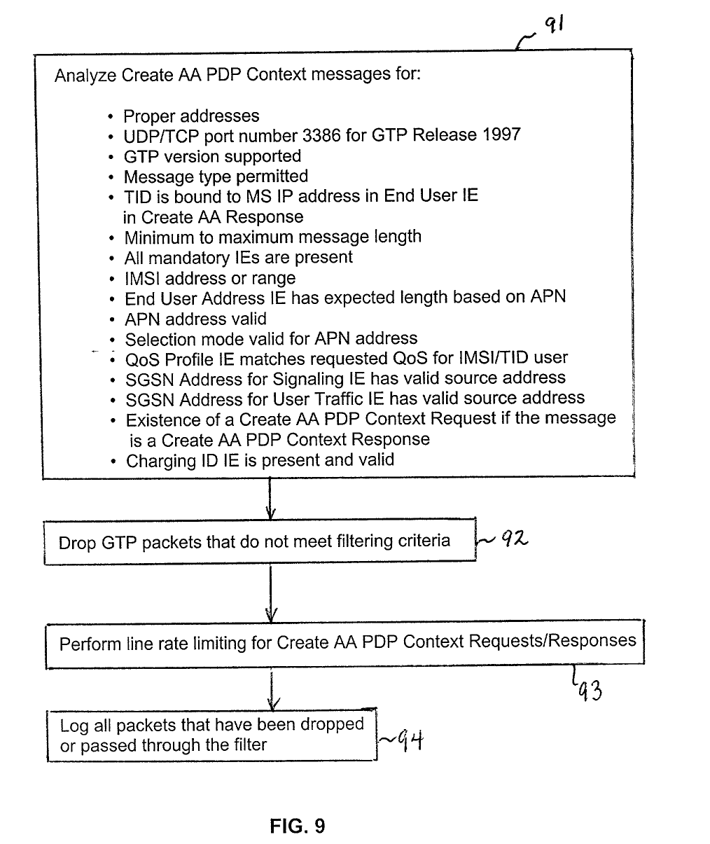

FIG. 9 is a flow chart illustrating the analysis and filtering performed on Create AA PDP Context messages in the preferred embodiment of the present invention. At step 91, as for all messages and packets traversing the Gn and Gp interfaces, the GTP packets are first checked against the correct source and destination and mask addresses. Next, the packets are checked against the correct UDP/TCP port numbers expected. For GTP Version 0 Release 1997, the port number is 3386. This message type is only supported by GTP Version 0 Release 1997. The version number is then checked in the GTP header to verify that the version is GTP version 0 release 1997, and if not, the packet is dropped and logged. Next, the message type is checked to determine whether or not the message type (i.e., Create AA PDP Context Request or Create AA PDP Context Response) is permitted. The result is logged accordingly. The GTP Filter then verifies that the TID is bound to the IP address allocated to the MS in the End User IE in the Create AA Response message. The minimum to maximum message length is then checked in accordance with the message type, and it is verified that all mandatory IEs are present.

The GTP Filter may then check the End User Address IE. This check compares the length of the IE with the length expected based on the APN requested. In other words based on the IMSI and the APN address, the length value is checked accordingly for this request. The PDP Type Organization and PDP Type Number are checked to determine whether these are supported for this request in the user's GSN nodes. For example, if only Ipv4 is supported, and the PDP Type Number specifies Ipv6, then the request may be dropped.

The GTP Filter also determines whether the APN address is valid in the network. The GTP Filter determines whether the APN is permitted based on the source IP address of the request and the End User Address IE. The GTP Filter also verifies that this subscriber may access this APN based on the TID in the GTP header. The GTP Filter also checks that the selection mode is valid for this APN address. The APN specified in the Create PDP Context Request IE may permit only a subscriber-verified selection mode value. If the value is different, the packet is dropped because the selection mode is not valid, and/or the MS or network-provided APN subscription is not verified. The GTP Filter may also check the QoS Profile IE against what is requested for this IMSI/MSISDN user for this APN requested.

The “SGSN Address for Signaling” IE and the “SGSN Address for User Traffic” IE are then checked for a valid source address for a request of this message type. If the message Type is Create AA PDP Context Response, the GTP Filter verifies the APN address and that (1) a Create AA PDP Context Request initially exists (has been sent) for this Create AA PDP Context Request based on the source and destination of request, and that (2) the IMSI and Network Service Access Protocol Identifier (NSAPI)=TID. If a Create AA PDP Context Request was not sent, the packet is dropped and logged at the GTP Filter, or is sent through the GTP Filter.

The GTP Filter may also verify that the IE with the charging ID is present, and that the charging ID is valid (i.e., not 0) for a Create AA PDP Context Response message type. A response is only permitted where a request has been received, and if not, the request is dropped and logged. Some foreign networks may not permit this type of access where the user is a visiting MS and may not be permitted to gain access. The home network may not grant access to the Home GGSN based on this type of access and may deny the request based on which PLMN network sent the request, and based on the APN requested. As shown at step 92, GTP packets that do not meet the filtering criteria are dropped, while those meeting the criteria are passed through the filter. At step 93, Line Rate Limiting may also be applied to the Create AA PDP Context Request/Response Message types. All packets that have been dropped or have passed through the GTP Filter may be logged at step 94.

E. Delete AA PDP Context

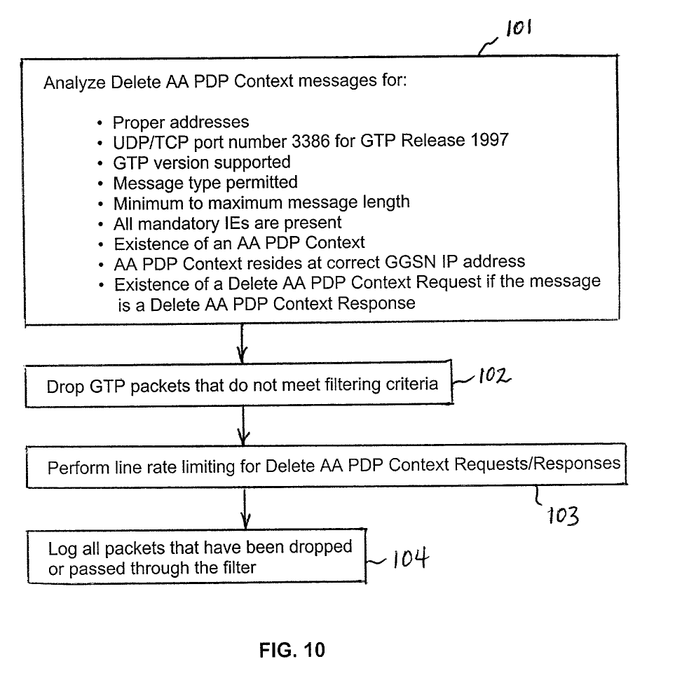

FIG. 10 is a flow chart illustrating the analysis and filtering performed on Delete AA PDP Context messages in the preferred embodiment of the present invention. At step 101, as for all messages and packets traversing the Gn and Gp interfaces, the GTP packets are first checked against the correct source and destination and mask addresses. Next, the packets are checked against the correct UDP/TCP port numbers expected. For GTP Version 0 Release 1997, the port number is 3386. This message type is only supported by GTP Version 0 Release 1997. The version number is then checked in the GTP header to verify that the version is GTP Version 0 Release 1997, and if not, the packet is dropped and logged. Next, the message type is checked to determine whether the message type (i.e., Delete AA PDP Context Request or Delete AA PDP Context Response) is permitted. The result is logged accordingly. The GTP Filter may also check the minimum to maximum message length in accordance with the message type, and it is verified that all mandatory IEs are present. The GTP Filter may also verify that an AA PDP Context exists for this TID, and if not, the request is dropped and logged. It is also verified that the target address where the PDP Context resides (i.e. the GGSN IP address) is where the PDP Context is residing.

The GTP Filter only permits a Delete AA PDP Context Response message type when a Delete AA PDP Context Request has been received for this PDP Context TID. If a request has not been received, the Delete AA PDP Context Response is dropped. Thus, as shown at step 102, GTP packets that do not meet the filtering criteria are dropped, while those meeting the criteria are passed through the filter. At step 103, Line Rate Limiting may also be applied to the Delete AA PDP Context Request/Response Message types. All packets that have been dropped or have passed through the GTP Filter may be logged at step 104.

F. Error Indication

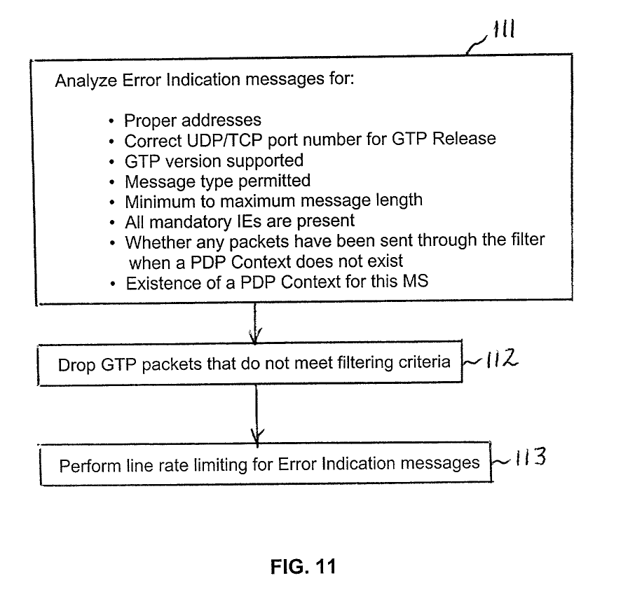

FIG. 11 is a flow chart illustrating the analysis and filtering performed on Error Indication messages in the preferred embodiment of the present invention. At step 111, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. First, the version number is checked in the GTP header to determine whether the version is supported, and if not the packet is dropped and logged. Next the GTP Filter determines whether the message type (Error Indication) is permitted to proceed through the GTP Filter. The packet is dropped or passed, and logged accordingly. The minimum to maximum message length is then checked in accordance with the message type, and it is verified that all mandatory IEs are present. The Error Indication message is then checked against whether any G-PDU packets have been sent through the GTP Filter when a PDP Context does not exist. In this case, the GTP Filter does not permit G-PDU packets through the GTP Filter when the PDP Context is not established and/or does not exist for this TID or TEID. The TID or TEID is then checked to determine whether a PDP Context exists for this MS, and if so, the message is permitted. The Error Indication message may be ignored when it is sent to a GSN or RNC node.

Thus, as shown at step 112, GTP packets that do not meet the filtering criteria are dropped, while those meeting the criteria are passed through the filter. At step 113, Line Rate Limiting may also be applied to the Error Indication Message types.

G. PDU Notification

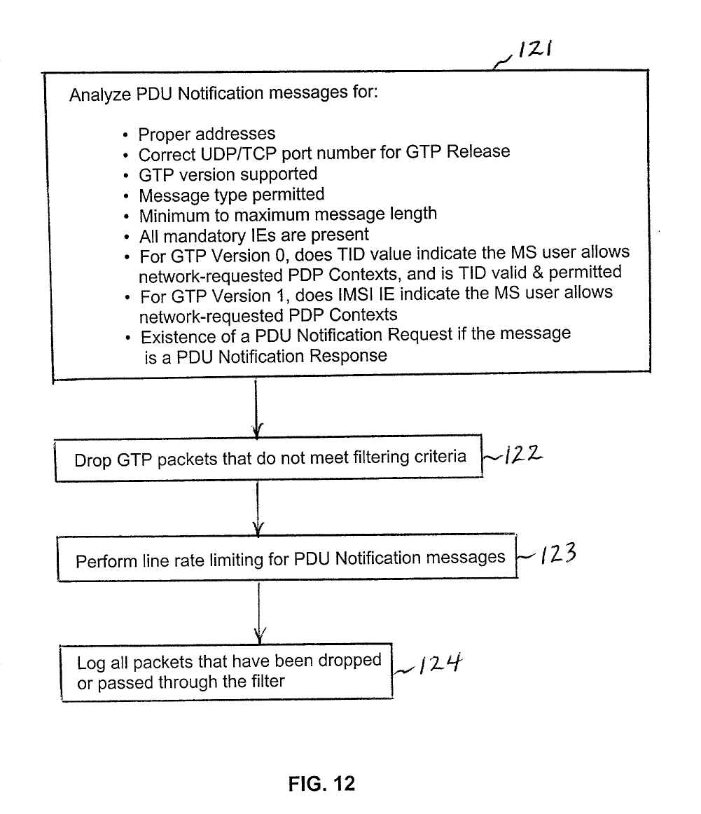

FIG. 12 is a flow chart illustrating the analysis and filtering performed on PDU Notification messages in the preferred embodiment of the present invention. At step 121, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. First, the version number is checked in the GTP header to determine whether the version is supported, and if not the packet is dropped and logged. Next the GTP Filter determines whether the message type (PDU Notification Request/Response) is permitted to proceed through the GTP Filter. The packet is dropped or passed, and is logged accordingly. The minimum to maximum message length is then checked in accordance with the message type, and it is verified that all mandatory IEs are present.

For GTP Version 0 Release 1997, the TID value in the GTP header is checked to determine whether this MS user allows network-requested PDP Contexts, and that the TID is valid/permitted in the PLMN network. For GTP Version 1 Release 1999, the IMSI IE is used to perform the same check as described above. If the message type is PDU Notification Response, the GTP Filter only allows the message to pass if (1) this service is supported, (2) a PDU Notification Request has first been received, and (3) the TID is valid and matches the TID in the PDU Notification Request. Thus, as shown at step 122, GTP packets that do not meet the filtering criteria are dropped, while those meeting the criteria are passed through the filter. At step 123, Line Rate Limiting may also be applied to the PDU Notification Message types. All packets that have been dropped or have passed through the GTP Filter may be logged at step 124.

H. PDU Notification Reject

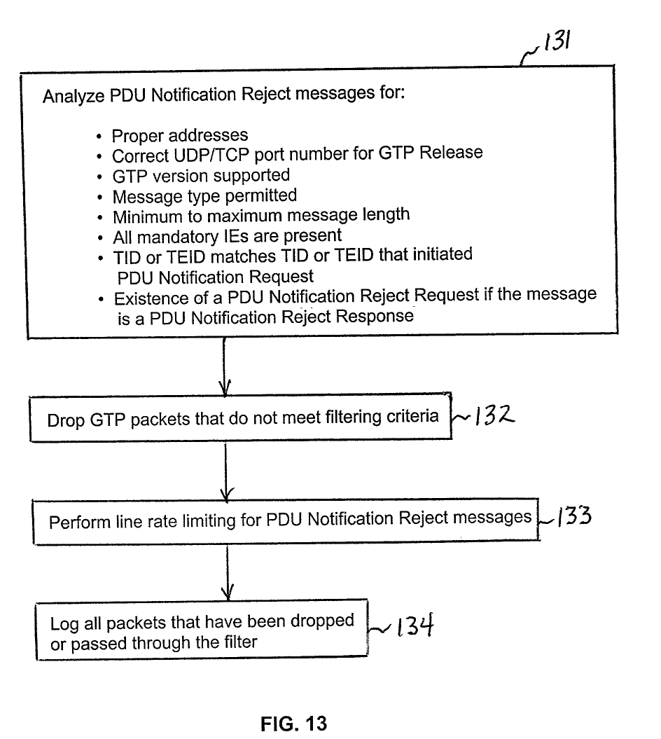

FIG. 13 is a flow chart illustrating the analysis and filtering performed on PDU Notification Reject messages in the preferred embodiment of the present invention. At step 131, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. First, the version number is checked in the GTP header to determine whether the version is supported, and if not the packet is dropped and logged. Next the GTP Filter determines whether the message type (PDU Notification Request/Response) is permitted to proceed through the GTP Filter, and is logged accordingly. The minimum to maximum message length is also checked in accordance with the message type, and it is verified that all mandatory IEs are present.

The GTP Filter may then verify in the GTP header that the TID or TEID is the same as the TID that initiated the PDU Notification Request. When a PDU Notification Reject Response is received, the GTP Filter checks that a PDU Notification Reject Request has been received for this TID/TEID, and if not, the message/packet is dropped. Thus, as shown at step 132, GTP packets that do not meet the filtering criteria are dropped, while those meeting the criteria are passed through the filter. At step 133, Line Rate Limiting may also be applied to the PDU Notification Reject Message types. All packets that have been dropped or have passed through the GTP Filter may be logged at step 134.

Mobility Management

A. Identification

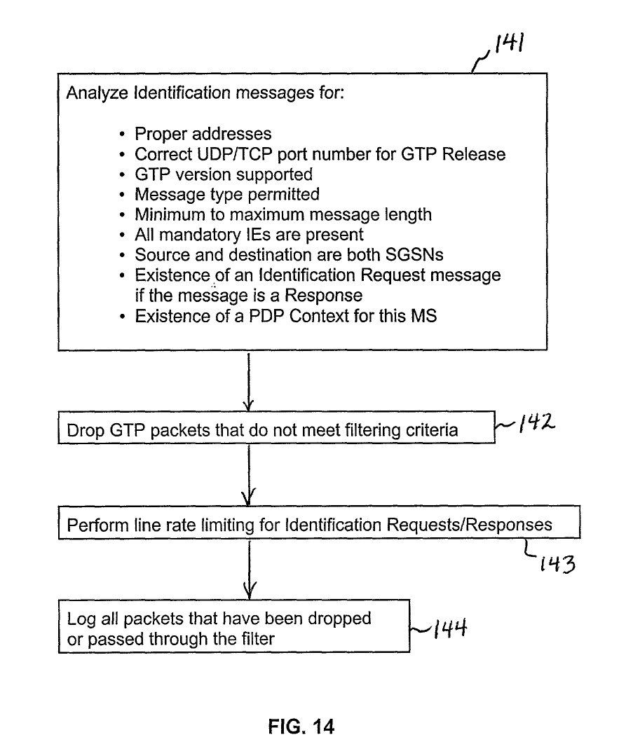

FIG. 14 is a flow chart illustrating the analysis and filtering performed on Identification messages in the preferred embodiment of the present invention. At step 141, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. First, the version number is checked in the GTP header to determine whether the version is supported, and if not the packet is dropped and logged. Next the GTP Filter determines whether the message type (Identification Request/Response) based on the source IP address is permitted to proceed through the GTP Filter. The packet is dropped or passed, and is logged accordingly. The minimum to maximum message length is also checked in accordance with the message type, and it is verified that all mandatory IEs are present. The GTP Filter only permits this message type between SGSNs. If the message is an Identification Response message, the GTP Filter verifies that an Identification Request message has been received. The existence of an active PDP Context for this MS is also verified.

Thus, as shown at step 142, GTP packets that do not meet the filtering criteria are dropped, while those meeting the criteria are passed through the filter. At step 143, Line Rate Limiting may also be applied to the Identification Request Message types. All packets that have been dropped or have passed through the GTP Filter may be logged at step 144.

B. SGSN Context Request/Acknowledge

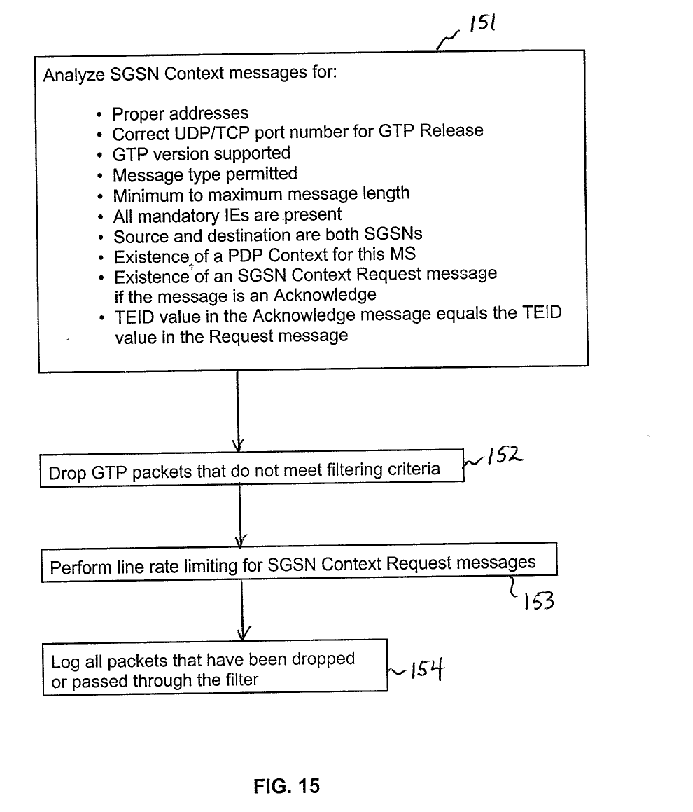

FIG. 15 is a flow chart illustrating the analysis and filtering performed on SGSN Context messages in the preferred embodiment of the present invention. At step 151, as for all messages and packets traversing the Gn and Gp interfaces, the GTP packets are first checked against the correct source and destination and mask addresses. Next, the packets are checked against the expected UDP/TCP port numbers, 3386 and 2123. The packet is then inspected at the GTP level, layer-5. First, the version number is checked in the GTP header to determine whether the version is supported, and if not the packet is dropped and logged. Next the GTP Filter determines whether the message type (SGSN Context Request/Acknowledge) based on the source IP address is permitted to proceed through the GTP Filter. The packet is dropped or passed, and is logged accordingly. The minimum to maximum message length is also checked in accordance with the message type, and it is verified that all mandatory IEs are present. The GTP Filter only permits this message type between SGSNs. For the Request message, the TID or TEID is also checked to determine whether a PDP Context exists for this MS, and if so, the message is permitted. The GTP Filter only permits an SGSN Context Acknowledge message when an SGSN Context Request message exists. The GTP Filter also verifies that the TEID value in the SGSN Context Acknowledge message is the same as what was sent in the SGSN Context Request/Response message.

Thus, as shown at step 152, GTP packets that do not meet the filtering criteria are dropped, while those meeting the criteria are passed through the filter. At step 153, Line Rate Limiting may also be applied to the SGSN Context Request Message types. All packets that have been dropped or have passed through the GTP Filter may be logged at step 154.

C. Forward Relocation

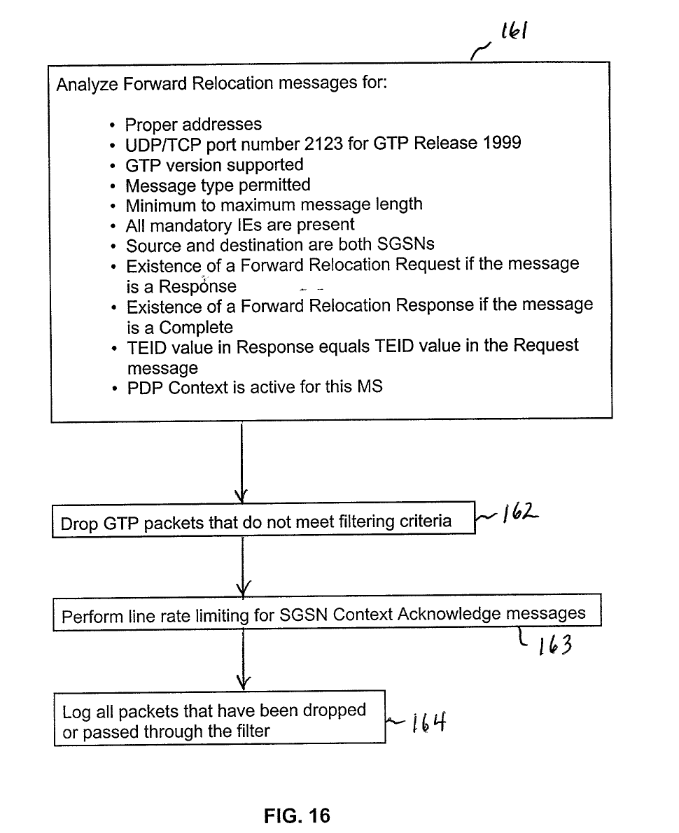

FIG. 16 is a flow chart illustrating the analysis and filtering performed on Forward Relocation messages in the preferred embodiment of the present invention. At step 161, as for all messages and packets traversing the Gn and Gp interfaces, the GTP packets are first checked against the correct source and destination and mask addresses. Next, the packets are checked against the correct UDP/TCP port numbers expected. For GTP Version 1 Release 1999, the port number is 2123. This message type is only supported by GTP Version 1 Release 1999. The packet is then inspected at the GTP level, layer-5. The version number is checked in the GTP header to verify that the version is GTP version 1 release 1999, and if not, the packet is dropped and logged. Next the GTP Filter determines whether the message type (Forward Relocation Request/Response/Complete) based on the source IP address is permitted to proceed through the GTP Filter. The packet is dropped or passed, and is logged accordingly. The minimum to maximum message length is also checked in accordance with the message type, and it is verified that all mandatory IEs are present. The GTP Filter only permits this message type between SGSNs. The GTP Filter only permits a Forward Relocation Response message if a Forward Relocation Request message has already been received. A Forward Relocation Complete message is permitted only when a Forward Relocation Response message has been received. The GTP Filter also verifies that the TEID value in the Forward Relocation Response message is the same as what was sent in the Forward Relocation Request message. Finally, the GTP Filter verifies that there is a PDP Context that is active for this MS.

Thus, as shown at step 162, GTP packets that do not meet the filtering criteria are dropped, while those meeting the criteria are passed through the filter. At step 163, Line Rate Limiting may also be applied to the Forward Relocation message types. All packets that have been dropped or have passed through the GTP Filter may be logged at step 164.

D. Relocation Cancel

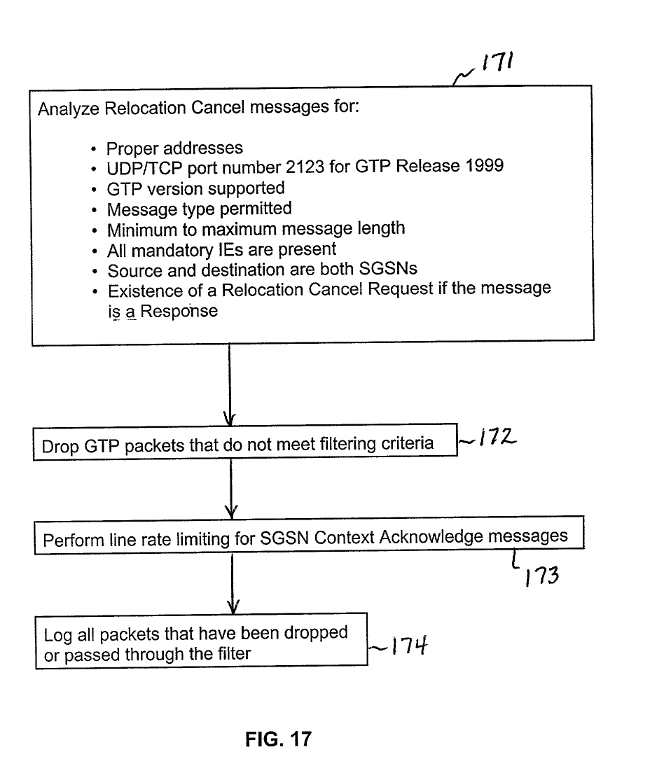

FIG. 17 is a flow chart illustrating the analysis and filtering performed on Relocation Cancel messages in the preferred embodiment of the present invention. At step 171, as for all messages and packets traversing the Gn and Gp interfaces, the GTP packets are first checked against the correct source and destination and mask addresses. Next, the packets are checked against the correct UDP/TCP port numbers expected. For GTP Version 1 Release 1999, the port number is 2123. This message type is only supported by GTP Version 1 Release 1999. The packet is then inspected at the GTP level, layer-5. The version number is checked in the GTP header to verify that the version is GTP version 1 release 1999, and if not, the packet is dropped and logged. Next the GTP Filter determines whether the message type (Relocation Cancel Request/Response) based on the source IP address is permitted to proceed through the GTP Filter. The packet is dropped or passed, and is logged accordingly. The minimum to maximum message length is also checked in accordance with the message type, and it is verified that all mandatory IEs are present. The GTP Filter only permits this message type between SGSNs. The GTP Filter only permits a Relocation Cancel Response message if a Relocation Cancel Request message has already been received.

Thus, as shown at step 172, GTP packets that do not meet the filtering criteria are dropped, while those meeting the criteria are passed through the filter. At step 173, Line Rate Limiting may also be applied to the Relocation Cancel message types. All packets that have been dropped or have passed through the GTP Filter may be logged at step 174.

The GTP Filter may also determine from the GTP header, a source IP address of a selected signaling message, the MSISDN of the originating MS, and an APN specified by the MS. The GTP Filter may then permit or deny packets based upon a determination of whether it is permitted for an MS having the determined MSISDN to request the requested APN from the source IP address and port number determined from the GTP header.

It is thus believed that the operation and construction of the present invention will be apparent from the foregoing description. While the GTP Filter and method shown and described has been characterized as being preferred, it will be readily apparent that various changes and modifications could be made therein without departing from the scope of the invention as defined in the following claims.

What is claimed is:

1. A method of filtering data packets in General Packet Radio Service (GPRS) Tunneling Protocol (GTP) signaling messages between service nodes in a GPRS network, said method comprising the steps of:
analyzing at least one GTP signaling message against a plurality of filtering criteria; and
responsive to the analyzing step, selectively dropping data packets from the GTP signaling message or allowing the packets to pass.

2. The method of filtering data packets of claim 1 wherein the step of analyzing at least one GTP signaling message includes analyzing messages selected from a group consisting of:
GTP Path Management messages;
GTP Tunnel Management messages;
GTP Mobility Management messages; and
GTP Location Management messages.

3. The method of filtering data packets of claim 1 wherein the step of analyzing at least one GTP signaling message includes the steps of:
verifying that the data packets in the GTP signaling message contain correct source, destination, and mask addresses;
verifying that the data packets in the GTP signaling message contain User Datagram Protocol/Transmission Control Protocol (UDP/TCP) port numbers that are consistent with the GTP version number; and
inspecting the data packets at the GTP level, (Open Systems Interconnect (OSI) layer-5).

4. The method of filtering data packets of claim 3 wherein the step of inspecting the data packets at the GTP level includes:
determining whether a destination node supports the GTP version specified in the data packet header;
determining whether the message type specified in the data packet header is permitted by the network; and
verifying that the message length is within an allowable minimum to maximum message length for the message type.

5. The method of filtering data packets of claim 3 wherein the step of inspecting the data packets at the GTP level includes determining whether the message is a response message of a particular message type, and if so, determining whether a corresponding request message of the same message type exists.

6. The method of filtering data packets of claim 3 wherein the step of inspecting the data packets at the GTP level includes allowing selected message types to pass only if the signaling message is being sent between nodes of a specified type.

7. The method of filtering data packets of claim 3 wherein the step of inspecting the data packets at the GTP level includes determining that an End User Address Information Element has a length that matches an expected length, said expected length being based upon an Access Point Name (APN) specified in a Create Packet Data Protocol (PDP) Context Request Information Element.

8. The method of filtering data packets of claim 7 wherein the step of inspecting the data packets at the GTP level also includes determining that a specified selection mode is permitted by the specified APN.

9. The method of filtering data packets of claim 7 wherein the step of inspecting the data packets at the GTP level also includes determining that a specified Mobile Station Integrated Services Digital Network (MSISDN) value is permitted for the specified APN.

10. The method of filtering data packets of claim 3 wherein the step of inspecting the data packets at the GTP level includes ensuring that a Packet Data Protocol (PDP) Context exists for an International Mobile Station Identifier (IMSI) specified in the signaling message.

11. The method of filtering data packets of claim 10 wherein the step of ensuring that a PDP Context exists for the IMSI specified in the signaling message includes checking a Tunnel Identifier (TID) or a Tunnel Endpoint Identifier (TEID) to ensure that a PDP Context exists for the IMSI.

12. The method of filtering data packets of claim 3 wherein the step of inspecting the data packets at the GTP level includes verifying that a Serving GPRS Support Node (SGSN) Address for Signaling Information Element has a valid source address for the message type specified in the data packet header.

13. The method of filtering data packets of claim 12 wherein the step of inspecting the data packets at the GTP level also includes verifying that an SGSN Address for User Traffic Information Element has a valid source address for the message type specified in the data packet header.

14. The method of filtering data packets of claim 3 wherein the step of inspecting the data packets at the GTP level includes the steps of:
verifying that a Charging Identification Information Element is present in the data packet header; and
verifying that the Charging Identification is valid.

15. The method of filtering data packets of claim 1 wherein the step of selectively dropping data packets includes dropping data packets that do not meet the filtering criteria.

16. The method of filtering data packets of claim 15 further comprising logging all packets that have been dropped and all packets that have been passed through during the selective dropping step.

17. The method of filtering data packets of claim 1 further comprising performing line rate limiting for the GTP signaling message.

18. A method of filtering data packets in General Packet Radio Service (GPRS) Tunneling Protocol (GTP) signaling messages between service nodes in a GPRS network, said method comprising the steps of:
analyzing selected messages from GTP Path Management messages, GTP Tunnel Management messages, GTP Mobility Management messages, or GTP Location Management messages against a plurality of filtering criteria; and
responsive to the analyzing step, dropping data packets that do not meet the filtering criteria while allowing data packets that meet the criteria to pass.

19. The method of filtering data packets of claim 18 wherein the step of analyzing selected messages includes the steps of:
verifying that the data packets in the selected messages contain correct source, destination, and mask addresses;
verifying that the data packets in the selected messages contain User Datagram Protocol/Transmission Control Protocol (UDP/TCP) port numbers that are consistent with the GTP version number; and
inspecting the data packets at the GTP level (Open Systems Interconnect (OSI) layer-5).

20. The method of filtering data packets of claim 19 wherein the step of inspecting the data packets at the GTP level includes:
determining whether a destination node supports the GTP version specified in the data packet header;
determining whether the message type specified in the data packet header is permitted by the network;
verifying that the message length is within an allowable minimum to maximum message length for the message type; and
determining whether a particular message is a response message of a particular message type, and if so, determining whether a corresponding request message of the same message type exists.

21. The method of filtering data packets of claim 19 wherein Internet Protocol (IP) packets in the GTP messages include a GTP header, and the step of inspecting the data packets at the GTP level includes:
determining from the GTP header:
a source IP address of a selected signaling message;
an identifier for an originating mobile station; and
an Access Point Name (APN) specified by the mobile station; and
determining whether it is permitted for the mobile station having the determined identifier to request the determined APN from the port number and source IP address in the GTP header.

22. The method of filtering data packets of claim 21 wherein a GTP message further comprising the step of limiting access to an APN when the mobile station is roaming in an untrusted network.

23. The method of filtering data packets of claim 19 wherein Internet Protocol (IP) packets in the GTP messages include a GTP header, and the method further comprises binding, in an End User Information Element in the GTP header, a Tunnel Identifier (TID) with the IP address assigned to the mobile station and with a Packet Data Protocol (PDP) Context established to conduct a data session.

24. The method of filtering data packets of claim 19 wherein Internet Protocol (IP) packets in the GTP messages include a GTP header, and the method further comprises binding, in an End User Information Element in the GTP header, a Tunnel Endpoint Identifier (TEID) with the IP address assigned to the mobile station and with a Packet Data Protocol (PDP) Context established to conduct a data session.

25. The method of filtering data packets of claim 19 wherein the step of inspecting the data packets at the GTP level includes inspecting a source address in a request from the mobile station to determine whether the mobile station's International Mobile Station Identifier (IMSI) address falls within an appropriate range for the Mobile Network Code (MNC) and Mobile Country Code (MCC) of the network operator.
